(19) United States
(12) Patent Application Publication
(10) Pub. No.: US 2019/0196539 A1
(43) Pub. Date: Jun. 27, 2019

(54) Privacy Screen Attached by Micro-suction Tape

(71) Applicant: Vincent Gerard Dominique Cassar, Geneva (CH)

(72) Inventor: Vincent Gerard Dominique Cassar, Geneva (CH)

(21) Appl. No.: 16/056,574

(22) Filed: Aug. 7, 2018

Related U.S. Application Data
(60) Provisional application No. 62/610,527, filed on Dec. 27, 2017.

(51) Int. Cl. G06F 1/16; G02F 1/13

(52) U.S. Cl. CPC G06F 1/1609; G02F 1/1323; G06F 1/1637

(57) ABSTRACT

Disclosed herein are embodiments for a screen cover for covering electronic display screens. The cover comprises a plastic sheet configured to allow the passage of light from a display within a viewing angle in front of the display while substantially blocking the passage of light outside of the viewing angle. The cover further comprise a micro-suction tape attached to a back side of the casing, the tape comprising a plurality of microscopic cavities configured to create a partial vacuum that removably attaches the tape to the display.

### BACKGROUND

### Technical Field

Embodiments generally relate to monitor screen protectors, and in particular to a privacy screen attached by micro-suction.

### Background

As technology advances, the use of electronic devices is becoming ever more prevalent. Cell phones, laptops, and other devices are commonly used in public where others nearby can see contents of their screens. To promote privacy, a number of screen filters or privacy screens have been created to inhibit the viewing range of the screen. Privacy screens refer to translucent, semi-translucent, and transparent substrates that can be mounted to electronic device' screens. These devices function by reducing the viewing angle of the screen, thus preventing it from being viewed from the side. This is accomplished by a specific nanostructure that diverts light generally perpendicular to the plane of the screen.

Currently, privacy screens are attached to the screen by an adhesive or magnet(s), often resulting in a number of problems. Using adhesive, the privacy screen must be applied evenly to reduce bubbling between the privacy screen and the surface of the monitor. Removal of the privacy screen leaves adhesive residue on the screen which can be difficult to clean. Using magnets can lead to permanent damage to the electronic device. Furthermore, in some current products, auxiliary attachment members are affixed to the display of an electronic device and releasably engage the privacy screen. These devices require the user to carry extra equipment when they are mobile.

### SUMMARY

Based on the foregoing, there is a need in the market for a non-adhesive and non-magnetic privacy screen that can be easily removed and reapplied without consequence. It would be desirable to have a privacy screen which can easily be mounted, removed and remounted without consequence to the display of a computing or electronic device. Therefore, there currently exists a need in the industry for a non-adhesive and non-magnetic privacy screen that can be easily put on and removed, without any negative effect.

Disclosed is a privacy screen including one or more pieces of micro-suction tape. This tape has thousands of microscopic craters on its surface, functioning like micro suction cups. It sticks without glue to smooth surfaces such as glass or plastic.

Among other things, it is an object of the present invention improve privacy that does not suffer from any of the problems or deficiencies associated with previous solutions. The invention will now be described more fully hereinafter with reference to the accompanying drawings, which are intended to be read in conjunction with both this summary, the detailed description and any preferred and/or particular embodiments and variations specifically discussed or otherwise disclosed. This invention may, however, be embodied in many different forms and should not be construed as limited to the embodiments set forth herein; rather, these embodiments are provided by way of illustration only and so that this disclosure will be thorough, complete and fully conveys the full scope of the invention to those skilled in the art.

The embodiments disclosed above are only examples, and the scope of this disclosure is not limited to them. Particular embodiments may include all, some, or none of the components, elements, features, functions, operations, or steps of the embodiments disclosed above. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The accompanying drawings are incorporated herein and form a part of the specification.

FIG. 1 shows a front elevation view of a privacy screen, according to particular embodiments.

FIG. 2 shows a back elevation view of privacy screen, according to particular embodiments.

FIG. 3 shows a side elevation view of privacy screen, according to particular embodiments.

FIG. 4 shows privacy screen mounted and in use on an electronic device display, according to particular embodiments.

FIG. 5 shows privacy screen being disengaged from an electronic device without consequence, according to particular embodiments.

### DETAILED DESCRIPTION

Provided herein are embodiments for a privacy screen attached by micro-suction tape. The privacy screen may be configured to skew light such that the display of the electronic device is only visible in a predetermined range.

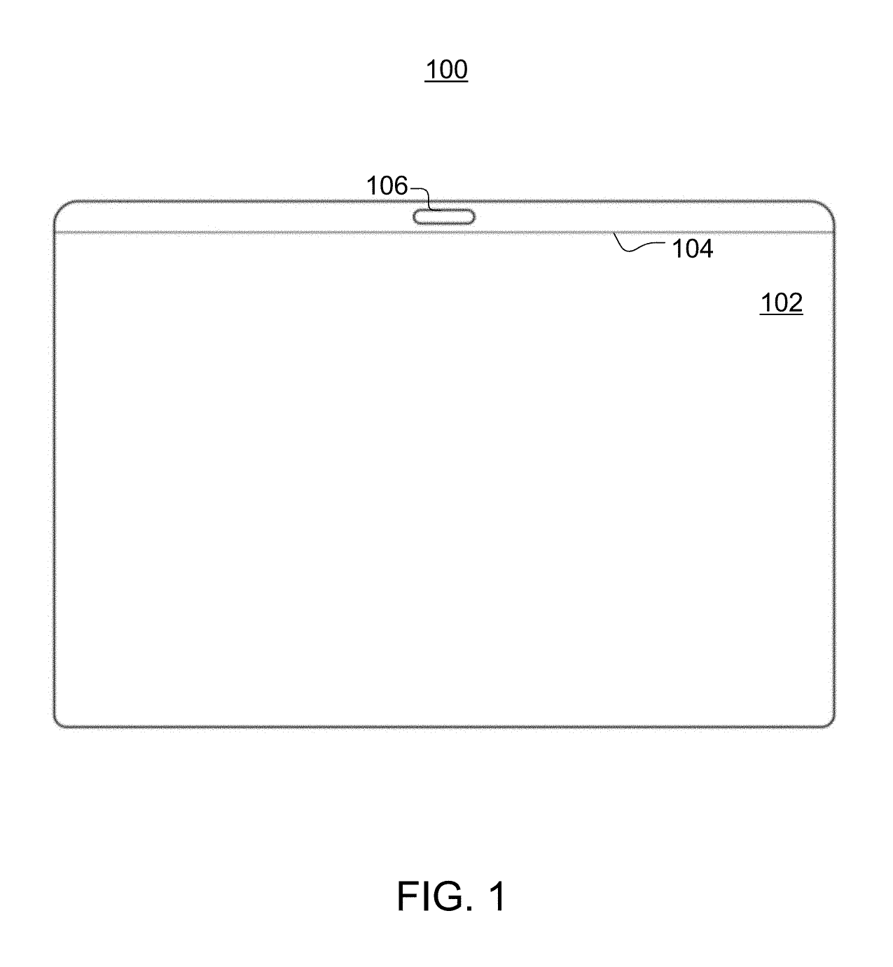

FIG. 1 shows a front elevation view of a privacy screen 100, according to particular embodiments. The front view is the view facing a user when privacy screen 100 is removably attached to an electronic display. Privacy screen 100 may further include a plastic sheet 102 that may extend through the length of the privacy screen and hold a micro-suction tape 104. Screen 100 may further include an aperture 106 that is positioned to avoid blocking the functionality of a camera or other sensor that may form part of the electronic device. Privacy screen 100 reduces the viewing angle of the electronic display to ensure only a user substantially in front of the display can view its contents.

Micro-suction tape 104 may be affixed using conventional adhesive along a length of the privacy screen. In particular embodiments, micro-suction tape 104 may be affixed along plastic sheet 100 using a non-adhesive material. As an example, plastic screen 100 may further comprise a plastic casing around the perimeter of the plastic sheet 102 designed to hold micro-suction tape 104.

While a single micro-suction tape 104 is shown in the figures, this disclosure contemplates any suitable number of micro-suction tapes 104. As an example, screen 100 may include separate micro-suction tapes 104 along the edges of the screen, or a single tape 104 in an inverse U-shape along the border of screen 100, etc. While micro-suction tape 104 is shown on the top edge of the casing in the figures, it should the understood the micro-suction tape can be attached in any suitable position. As an example, micro-suction tape 104 may be further attached to the side edges, bottom edges, middle sections of the screen, etc.

While a single aperture 106 is shown in the figures, it should be understood that screen 100 may include any number of apertures 106 for other devices on the display. For example, screen 100 may include apertures 106 for additional camera lenses, microphones, speakers, etc.

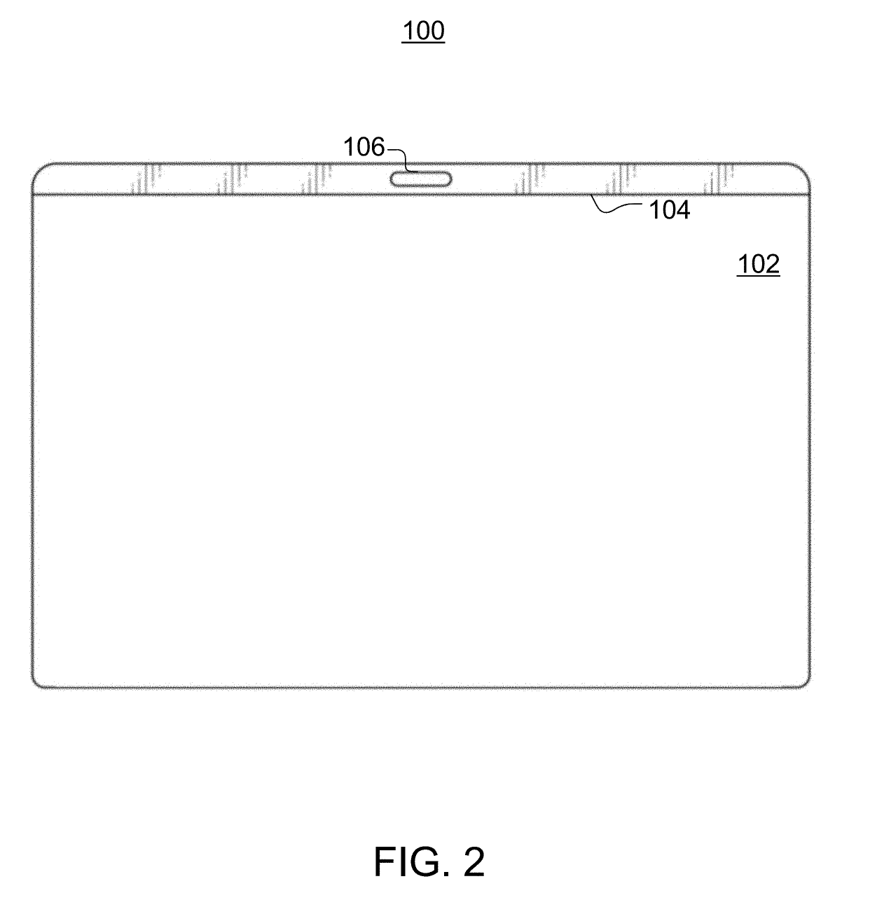

FIG. 2 shows a back elevation view of privacy screen 100, according to particular embodiments. When in use, the back view faces and is in contact with the electronic device display. The back side of micro-suction tape 104 may comprise many small (e.g., microscopic) cavities or bubbles on its surface. When tape 104 is pressed against a flat surface, air is squeezed out of the cavities. Micro-suction tape 104 is comprised of a material having sealing properties, and when the tape is pulled off the surface the cavities create partial vacuums between the tape and the surface that create a force that prevents the tape from being removed from the surface. This force is similar to the mechanism of suction cups, and is enough to maintain privacy screen 100 in place during normal usage. However, with enough force or by pulling from the edge of the tape, a user can easily remove privacy screen 100. In this manner, a user can easily attach and remove the privacy screen without leaving any adhesive residue or having to use magnets or other auxiliary components for attachment.

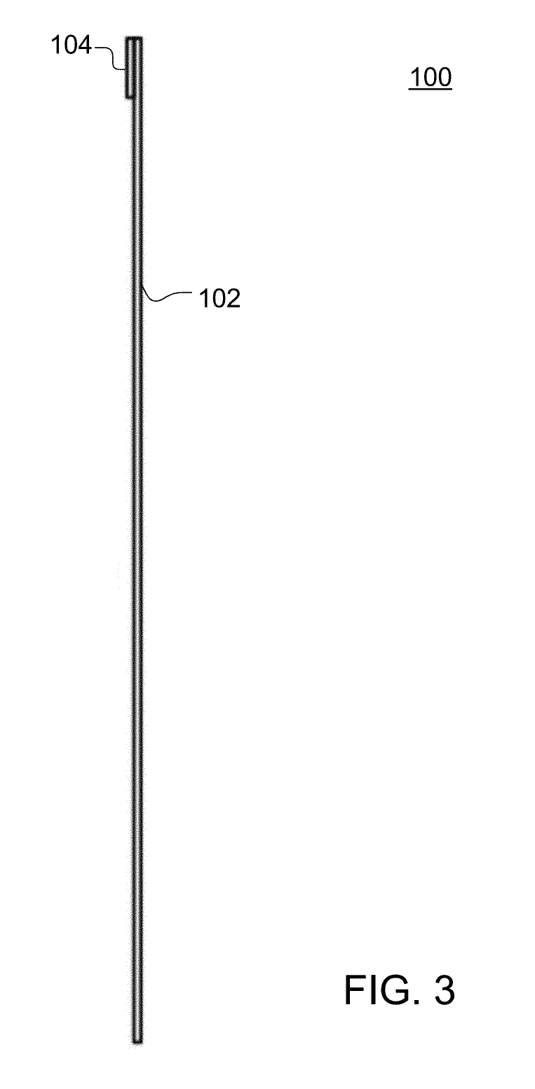

FIG. 3 shows a side elevation of privacy screen 100, according to particular embodiments. While micro-suction tape 104 is shown protruding from the surface of plastic sheet 102, it should be understood that the level of protrusion is for visualization purposes and may be less pronounced than shown.

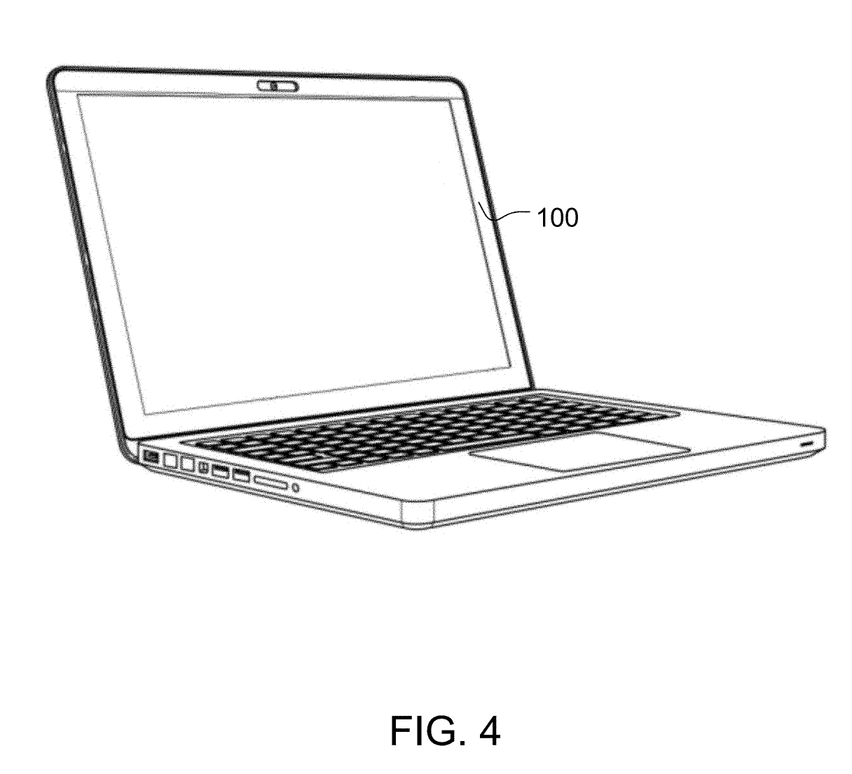

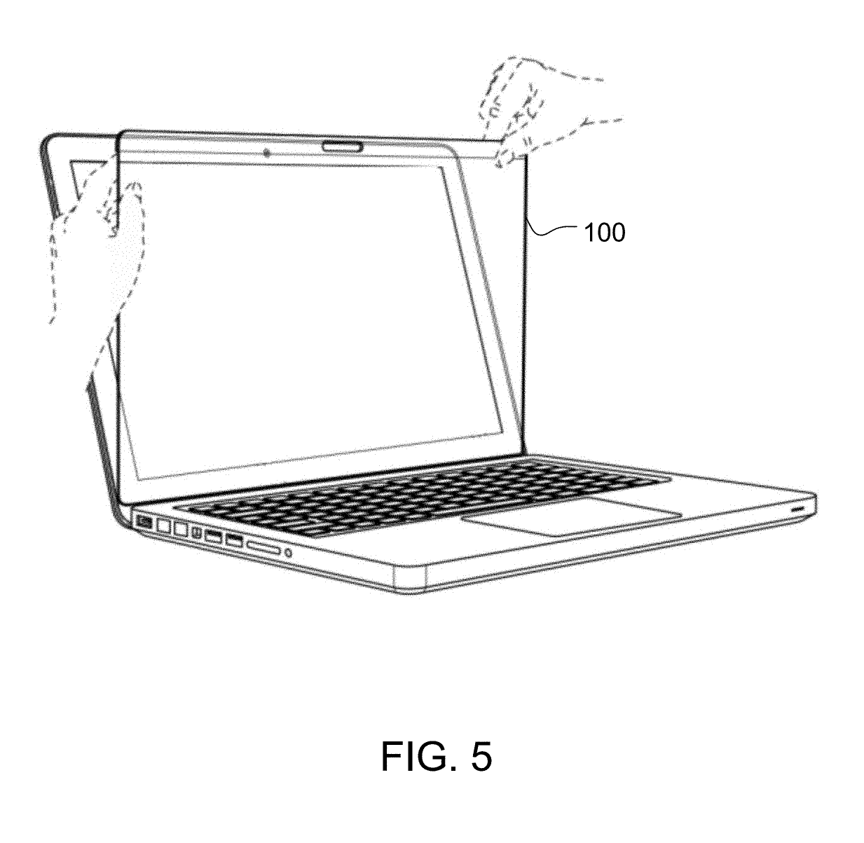

In particular embodiments, privacy screen 100 allows light to be emitted in a 60-degree array. In particular embodiments, privacy screen 100 may be used as an aftermarket privacy screen cover for the display screen of an electronic device. The privacy screen may be easily mounted, removed and remounted without consequence to the display of the electronic device. FIG. 4 shows privacy screen 100 mounted and in use on an electronic device display, according to particular embodiments. FIG. 5 shows privacy screen 100 being disengaged from an electronic device without consequence.

In particular embodiments, micro-suction tape 104 is made of acrylic foam. The surface of the micro-suction tape may comprise thousands of microscopic craters that work by creating many partial vacuums between the tape and the target surface. In particular embodiments, the tape is not pressure sensitive, can re-bond repeatedly, and leaves no residue on the target surface. Micro-suction tape 104 may have any suitable thickness. In particular embodiments, the thickness of the micro-suction tape 104 is between 0.1 mm and 0.9 mm.

Micro-suction component 104 may be disposed within a perimeter of a border of the display of the electronic device, such that the micro-suction component does not block the display. Aperture 106 is positioned such that the functionality of a camera or other sensor is not hindered by privacy screen 100.

In particular embodiments, plastic sheet 102 may include one or more of an anti-reflective scratch resistant coating or an anti-blue coating. The selective transparency of the screen 100 may be accomplished through an antireflective coating. For example, micro louvers, anti-reflective coatings, or other privacy components may be positioned to permit light to pass on a vector perpendicular to the plane of the screen. In this manner, someone standing past the visible angle allowed by the micro louvers will not be able to see the displays emitted light. In particular embodiments, the privacy screen allows for a 60-degree viewing angle, but larger (e.g., 90-degree) and shorter (e.g., 45-degree) angles are contemplated within this disclosure. Other means for producing a privacy screen with an inhibited viewing angle may be used.

In particular embodiments, the privacy screen is comprised of polyethylene terephthalate (PET). However, other semi-crystalline resins may be used. The privacy screen may be rigid, such that the privacy screen is in complete contact with the display surface of the electronic device. The coating of the privacy screen is antireflective and 3H PET scratch resistant.

In particular embodiments, one or more pieces of micro-suction tape are positioned on the back side of the privacy screen. In particular embodiments, micro-suction components extend along a length of the privacy screen and are dimensioned to fit within the elevated perimeter of the electronic device. The micro-suction component may releasably engaged with the display of the device allowing the user to easily apply and remove the privacy screen.

In particular embodiments, the micro-suction component is dimensioned similar to the dimension of the privacy screen. This allows for the micro-suction component to interact with the display of the electronic device. In particular embodiments, the privacy screen has a generally rectangular shape dimensioned to correspond to a generally rectangular display of an electronic device.

As discussed, the invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations. Many modifications, variations and other embodiments of the invention will come to mind of those skilled in the art to which this invention pertains, and which are intended to be and are covered by both this disclosure. It is indeed intended that the scope of the invention should be determined by proper interpretation and construction of the disclosure, including equivalents, as understood by those of skill in the art relying upon the complete disclosure at the time of filing.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible and are within the scope and spirit of the invention.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A screen cover for covering electronic display screens, the cover comprising:
a plastic sheet configured to allow the passage of light from a display within a viewing angle in front of the display while substantially blocking the passage of light outside of the viewing angle; and
a micro-suction tape attached to a back side of the casing, the tape comprising a plurality of microscopic cavities configured to create a partial vacuum that removably attaches the tape to the display.

2. The cover of claim 1, wherein the plastic sheet further comprises an aperture positioned to align with a device on the electronic display screen.

3. The cover of claim 2, wherein the device on the electronic display screen comprises a camera lens.

4. The cover of claim 2, wherein the plastic sheet further comprises one or more additional aperture positioned to align with one or more additional devices on the electronic display screen.

5. The cover of claim 1, wherein the plastic sheet is comprised of a semi-crystalline resin.

6. The cover of claim 6, wherein the semi-crystalline resin comprises polyethylene terephthalate.

7. The cover of claim 1, wherein the micro-suction tape is positioned along a top edge of the back side of the casing.

8. The cover of claim 1, further comprising one or more additional micro-suction tapes attached to the back side of the casing.

9. The cover of claim 1, wherein the viewing angle is substantially 60 degrees.

10. The cover of claim 1, wherein the viewing tape has a thickness of between 0.1 mm and 0.9 mm.

11. The cover of claim 1, wherein the plastic sheet further comprises an anti-reflective coating.

12. The cover of claim 1, wherein the plastic sheet further comprises a scratch resistant coating.
